(19) United States
(12) Patent Application Publication
(10) Pub. No.: US 2020/0302556 A1
(43) Pub. Date: Sep. 24, 2020

(54) CROP RECOMMENDATION

(71) Applicant: International Business Machines Corporation, Armonk, NY (US)

(72) Inventors: Livia Elanor Stacey, Basingstoke (GB); David Alec Selby, Fareham (GB)

(21) Appl. No.: 16/360,213

(22) Filed: Mar. 21, 2019

(51) Int. Cl. G06Q 50/02; G06Q 30/06; G06Q 10/06

(52) U.S. Cl. CPC G06Q 50/02; G06Q 10/06315; G06Q 30/0631

(57) ABSTRACT

Concepts for crop recommendation for a geographical space are presented. One example comprises determining a seed treatment recommendation based on at least one of: location data relating to the geographical space; economic data relating to one or more crop types; treatment data relating to the one or more crop types; and crop data relating to the one or more crop types. A recommended crop type is determined based on the seed treatment recommendation. Weather information for the geographical space for a predetermined timeframe prior to a planned planting date is also determined. A seed planting amount is determined based on the recommended crop type and the weather information.

### BACKGROUND

The present disclosure relates generally to the agricultural production, and more particularly to a method for crop recommendation for a geographical space.

Agricultural production has inherent uncertainties, variations and risks. Accurate modeling or prediction of agricultural production may allow farmers to make better decisions for reducing their exposure to risk and/or taking advantage of favorable crop production conditions. However, many variables may have a large effect on crop yield.

### SUMMARY

The present disclosure seeks to provide a computer-implemented method for crop recommendation for a geographical space.

According to an aspect of the present disclosure there is provided computer-implemented method and computer program product for crop recommendation for a geographical space. The method comprises determining a seed treatment recommendation based on location data relating to the geographical space, economic data relating to one or more crop types, treatment data relating to the one or more crop types, and crop data relating to the one or more crop types. The method further comprises determining a recommended crop type, based on the seed treatment recommendation. The method further comprises determining weather information for the geographical space for a predetermined timeframe prior to a planned planting date. A seed planting amount is then determined based on the recommended crop type and the weather information.

According to yet another aspect of the disclosure, there is provided a system for crop recommendation for a geographical space. The system comprises a data processing unit configured to determine a seed treatment recommendation based on location data relating to the geographical space; economic data relating to one or more crop types; treatment data relating to the one or more crop types; and crop data relating to the one or more crop types. The data processing unit is also configured to determine a recommended crop type based on the seed treatment recommendation. The system also comprises a weather component configured to determine weather information for the geographical space for a predetermined timeframe prior to a planned planting date. The system also comprises a data analysis unit configured to determine a seed planting amount based on the recommended crop type and the weather information.

### BRIEF DESCRIPTION OF THE DRAWINGS

Preferred embodiments of the present disclosure will now be described, by way of example only, with reference to the following drawings, in which:

FIG. 1 depicts a pictorial representation of an example distributed system in which aspects of the illustrative embodiments may be implemented;

FIG. 2 is a block diagram of an example system in which aspects of the illustrative embodiments may be implemented;

FIG. 3 is a simplified block diagram of an example embodiment of a system for crop recommendation for a geographical space according to an embodiment;

FIG. 4 is a flow diagram of a computer-implemented method for crop recommendation for a geographical space according to an embodiment;

FIG. 5 is a flow diagram of a computer-implemented method for determining weather information according to an embodiment; and

FIG. 6 illustrates a system according to an embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present disclosure constitute a method, it should be understood that such a method may be a process for execution by a computer (e.g., a computer-implemented method). The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present disclosure. For instance, a system may be a personal computer (PC), a server, or a collection of PCs and/or servers connected via a network such as a local area network, the Internet and so on to cooperatively execute at least one embodiment of the methods of the present disclosure.

It is proposed to take account of various factors to identify an optimal crop type and seed planting amount for a geographical space. Embodiments may, for example, employ machine learning, such as a stochastic optimization approach, with an objective function to maximize profit per hectare (or other unit of area).

It is proposed that identification and modeling/simulation of factors affecting crop management, crop production and seed purchasing in consideration of a geographic area may be beneficial for making recommendations or decisions in agricultural production.

Embodiments may be implemented in conjunction with farm management systems to make crop recommendations to an expert individual (e.g., a farmer), thereby aiding decision making Furthermore, historical data specific to a single geographical space may be leveraged to provide more accurate determinations that account for factors unique to the geographical space.

Feedback via a system or user input may enable employed algorithms or models to adapt to variations or changes in factors affecting crop production.

Proposed is a concept that leverages various types of data relating to a geographical space, crop types, economic factors, crop treatment considerations, etc. Such data may be obtainable, because it is available or not limited to a restricted geographical space, for example. Based on such information, a preferred or optimal crop type may be identified. Based on this identified crop type, and in consideration of weather information associated with a proposed planting location and planting date, a preferred or optimal seed planting amount may be determined.

By accounting for weather information in combination with a specific crop type, an inference about an optimal planting amount in limited geographic space may be made.

Embodiments may facilitate the generation of a model representing one or more relationships between factors associated with a crop type and/or a geographic space. This may, in turn, help to determine a crop type that is preferable for crop planting or production in the geographical space. Embodiments may therefore assist in identifying an optimal crop type for a geographic space.

A tool for enabling crop management systems to infer one or more preferred crop types for a geographical space may therefore be provided by a proposed embodiment. This may be used to manage crop purchasing and planting. It may also facilitate assessment of crop planting/production conditions for a geographical space over a temporal duration. Embodiments may therefore cater for crop requirements for localized environmental constraints and optimizers, which may change dynamically with respect to time and/or location.

By way of example, proposed embodiments may determine a probabilistic model for recommending crop type and/or seed planting amount based on various factors associated with a geographical space and the weather. The model may represent the impact of location, economic considerations, weather, and/or crop type requirements on profitability of crop production. The generated model may then be used to determine a preferred crop type and planting amount, so as to maximize crop production and/or profit. This information may, in turn, be used to instruct users (e.g., individuals with portable communication devices) what crop type to purchase and how much seed of that crop type to purchase. Proposed embodiments may thus provide a concept for suggesting localized considerations to facilitate optimized crop purchasing and production within a geographical space.

Accordingly, proposed embodiments may provide a tool or concepts for assisting in the determination as to what impact factors associated with a geographic space may have with respect to achievable or expected profit from crop production. This may help to improve an understanding of how crop production may be optimally managed at one or more geographic spaces within a larger geographic area, thus ensuring optimal crop yield or crop profit for example.

Embodiments may be useful for a wide range of crop types, because they may take into account crop-specific requirements when using a generated model to determine a preferred crop type or planting amount. As an example, one crop-type might be sensitive to the ground being too wet at planting, whereas another crop-type may just want as much rainfall as possible. The predetermined crop requirement would therefore be different, but the model would still allow for an estimate of rainfall to be obtained based on weather information and if the requirement will be met. Such information may then be used to identify what crop(s) should be planted within a geographical space to improve or optimize crop production.

Reference to a geographical space is to be taken to refer to a limited geographical area within which a crop may be planted within a larger geographic area. A geographical space may therefore be thought of as an area that, although it can be described using a single location identifier or label (e.g., field name, postal code/zip code, street, field, or other identifier), may comprise a plurality of locations or positions that may be defined/or identified within the geographical space. Accordingly, a geographical space may be described or identified using a geofence. Also, a geographical space may be time dependent, time varying and/or have an existence with is finite with respect to time. For example, a geographical space may be associated with (and even described with reference to) a particular crop type and this may change season-to-season and/or year-to-year. A geographical space may therefore be defined by the boundary of a crop, and may thus consist of one or more fields or crop planting lots.

Embodiments may, for example, enable a crop management system to infer optimal crop type or seed planting amount for a field (or group of fields) in consideration of various factors. Further, assessment or management of crop production over a temporal period may be enabled. Embodiments may therefore be particularly useful for crop production within a bounded area that extends across one or more fields. Data for a larger geographic area may be leveraged to establish relationships for a smaller geographical space (within the geographic area) which would otherwise not be possible (e.g., if trying to rely on data for the smaller geographical space only). Using such a relationship, combined with an understanding of requirements for a crop, recommendations for the smaller geographical space (e.g., to ensure required crop production profit) may then be inferred. With such recommendations identified, along with real-time information about weather for the bounded area, suggestions as to which crop should be planted (and how much of the crop to purchase or plant) may be established.

Embodiments may provide concepts that facilitate the efficient and effective provision of crop planting/production guidance for a geographical space.

By way of further example, embodiments may propose extensions to existing computer systems and/or crop management systems. Such extensions may enable a crop management system to provide additional functionality by leveraging proposed concepts. In this way, a conventional computer system or crop management system may be upgraded by implementing or ‘retro-fitting’ embodiments of the present disclosure.

Illustrative embodiments may provide concepts for analyzing and identifying links between factors that may influence crop production or crop profit for a geographical space, and such concepts may cater for changes over time. Dynamic crop recommendations concepts may therefore be provided by proposed embodiments. Modifications and additional steps to a traditional crop management system may also be proposed which may enhance the value and utility of the proposed concepts.

By way of example, a proposed embodiment may comprise determining a seed treatment recommendation based on one or more of: location data relating to the geographical space, economic data relating to one or more crop types, treatment data relating to the one or more crop types, and crop data relating to the one or more crop types. Based on the seed treatment recommendation, a recommended (e.g., optimal or preferred) crop type may then be determined. Also, weather information for the geographical space for a predetermined timeframe prior to a planned planting date may be determined. Based on the recommended crop type and the weather information, a seed planting amount (e.g., amount of seed) may be determined. Accordingly, unlike conventional concepts, embodiments may recommend a crop type and crop amount to purchase for a specific geographical space.

In some embodiments, determining a seed treatment recommendation may be further based on historical data relating to one or more crop types. By way of example, the historical data may comprise at least one of production history data relating to previously obtained crop production values for the one or more crop types and observation data relating previously-obtained observations for the one or more crop types. Such use of historical data may provide for improved or more accurate determinations, for example by accounting trends or patterns that would otherwise be ignored or overlooked.

Some embodiments may determine a seed planting amount by employing a stochastic optimization algorithm. Such an algorithm may, for example, be configured for identifying a crop amount which maximizes yield.

By way of further example, the location data may comprise at least one of soil data relating to the soil of the geographic space, irrigation status data relating to irrigation properties of the geographic space, and geographic data relating to geographic properties of the geographic space.

Also, the economic data may comprise at least one of crop pricing data relating to a current price of the one or more crop types, crop future data relating to future pricing of the one or more crop types, and refund data relating to refund availability for the one or more crop types, including both rebates and insurance payouts (e.g., for failed and/or destroyed crops).

Further, the treatment data may comprise at least one of treatment substance data relating to pesticide, herbicide, fungicide or fertilizer requirements of the one or more crop types; treatment pricing data relating to a current price of treatment substances for the one or more crop types; and treatment future data relating to future pricing of treatment substances for the one or more crop type.

The crop data may comprise at least one of yield data relating to expected yields of the one or more crop types, crop requirement data relating to planting or growth requirements of the one or more crop types, and irrigation data relating to irrigation requirements of the one or more crop types (e.g., the amount and schedule of irrigation, the orientation of the crop rows versus the angle of the sun and direction towards the water source, etc.).

In some embodiments, determining weather information may comprise: obtaining rainfall information relating to sensed rainfall for a geographic area within a time period, wherein the geographic area includes the geographical space; obtaining temperature information relating to sensed ambient temperature for the geographic area within the time period; generating a model based on the obtained rainfall information and temperature information, the model representing a relationship between rainfall and ambient temperature for the geographic area; and determining a temperature threshold for the geographical space based on the generated model, wherein the temperature threshold is for identifying a crop planting or production condition.

A geographical space for crop production (e.g., one or more crop fields) may be limited in size with respect to a larger geographic area (e.g., district, county, state or country). Thus, although information regarding weather (e.g., sensed rainfall) for a larger geographic area may be available, accurate information about weather for a limited geographic space may be unavailable or limited.

In other words, although information regarding weather (such as rainfall and/or ambient temperature) for a larger geographic area may be available, accurate information about weather for a limited geographic space may be unavailable or limited. However, due to available sensing/monitoring technology, this may not necessarily the case, thus meaning accurate information about particular weather parameters (such as sensed ambient temperature, for example) for a limited geographic space may be available (whereas information about other weather parameters, such as rainfall information, for the same limited geographic space may not be).

Accordingly, reliance on rainfall information and temperature information for a limited geographic space may make it difficult to establish an interdependence (correlation) between rainfall and temperature for the limited geographic space.

Proposed is an additional concept that leverages rainfall information relating to sensed rainfall for a geographic area (e.g., a larger area such as a town, city, state, etc.) and temperature information relating to sensed ambient temperature for the geographic area. Such rainfall and temperature information may be obtainable, because it is not limited to a restricted geographical space within the geographic area for example. Based on such information, a model representing a relationship between rainfall and ambient temperature for the geographic area may be generated. Using such a model, a temperature threshold identifying a crop planting or production condition for a limited/restricted geographical space within the geographic area may then be determined.

By using rainfall and temperature information that is obtainable for a larger geographic area, an interdependence (e.g., correlation) between rainfall and temperature for the larger geographic area may be identified. From this, an inference for a limited geographic space within the larger geographic area may be made. For instance, it may be inferred that the established interdependence between rainfall and temperature for the larger geographic area also applies equally to a limited geographic space within the larger geographic area. Additionally, or alternatively, it may be inferred that the established interdependence between rainfall and temperature for the larger geographic area also applies equally to a limited geographic space within larger geographic area, but with slight adjustment or modification to account for other factors (such as soil type, crop type, geographic features, etc.).

Embodiments may therefore facilitate the generation of a model representing a relationship between rainfall and ambient temperature for a geographic area. This may, in turn, help to determine a temperature that has a related value of rainfall that is preferable for crop planting or production in a geographical space of the geographic area. Embodiments may therefore assist in identifying a temperature condition for a geographic space within geographic area that may obtain a required or optimal crop.

In some embodiments, generating a model may comprise analyzing the obtained rainfall information and temperature information to determine a correlation between rainfall for the geographic area and ambient temperature for the geographic area. One or more functions for describing the determined correlation between rainfall for the geographic area and ambient temperature for the geographic area may then be determined. A model representing a relationship between rainfall and ambient temperature for the geographic area may then be generated based on the one or more functions. Over larger geographical spaces and/or time periods, a single function may be computed to avoid the need for highly granular individual models specific to locations.

For instance, analyzing the obtained rainfall information and temperature information may comprise processing the obtained rainfall information and temperature information with one or more machine learning algorithms to determine a correlation between rainfall for the geographic area and ambient temperature for the geographic area. Embodiments may therefore employ artificial intelligence and/or machine learning techniques for processing the rainfall information and temperature information. Regression techniques covering the relationship between two continuous variables may be appropriate, for example. However, it is noted that a relationship may be non-linear, and so this may be consideration in selection of an appropriate analysis process.

Some embodiments may further comprise obtaining information indicative of a detected ambient temperature for the geographic space; and detecting a crop planting or production condition for the geographical space based on the detected ambient temperature for the geographic space and the temperature threshold. Embodiments may therefore be adapted to indicate when a crop planting or production condition is met. This may be facilitate quick and simple identification of crop planting conditions for improved crop yield.

For example, embodiments may adapted to output a signal indicative of the detected crop planting or production for the geographical space.

In some embodiments, obtaining information indicative of a detected ambient temperature for the geographic space may comprise: obtaining at least one of: a control signal from a user or control system; and a sensor output signal from temperature sensor. Embodiments may therefore cater for different ways in which information about detected ambient temperature may be provided. This provides additional flexibility and/or enables more accurate temperature information to be obtained and used.

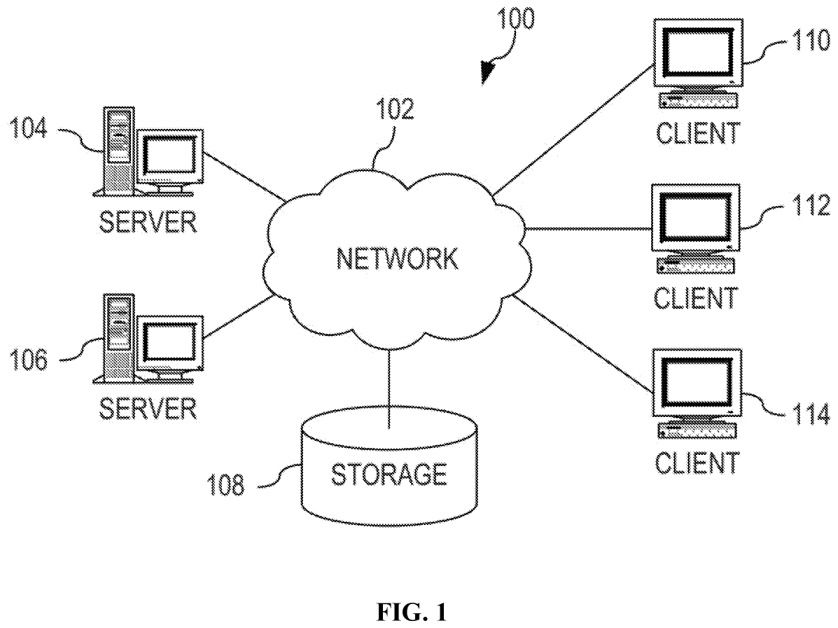

FIG. 1 depicts a pictorial representation of an example distributed system 100 in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed system 100. The network 102 may include various connection media, such as cable wire, wireless communication links, or fiber optic cables.

In the depicted example, a first server 104 and second server 106 are connected to the network 102 along with a storage unit 108. In addition, clients 110, 112, and 114 are also connected to the network 102. Clients 110, 112, and 114 may be, for example, personal computers, network computers, or the like. In the depicted example, the first server 104 provides data, such as boot files, operating system images, and applications to clients 110, 112, and 114. Clients 110, 112, and 114 may be clients to the first server 104 in the depicted example. The distributed system 100 may include additional servers, clients, and other devices (not shown).

In the depicted example, the distributed system 100 may be the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present disclosure, and therefore, the particular elements shown in FIG. 1 should not be considered limiting with regard to the environments in which the illustrative embodiments of the present disclosure may be implemented.

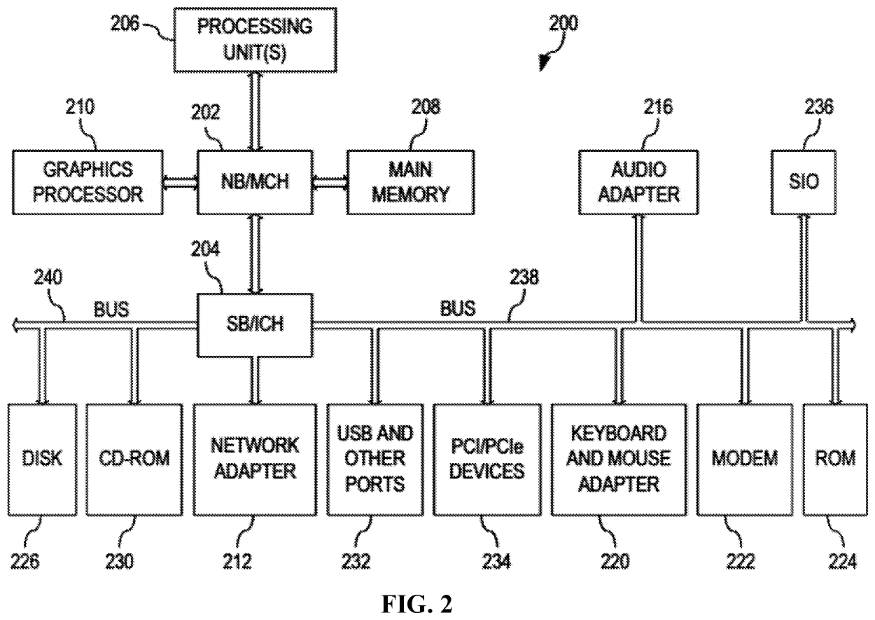

FIG. 2 is a block diagram of an example system 200 in which aspects of the illustrative embodiments may be implemented. The system 200 is an example of a computer, such as client 110 in FIG. 1, in which computer-usable code or instructions implementing the processes for illustrative embodiments of the present disclosure may be located.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through, for example, an accelerated graphics port (AGP).

In the depicted example, a network adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® eServer™ System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present disclosure may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present disclosure.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

A proposed concept may enhance crop production by providing recommendations of crop type and crop amount for a specific geographical space. Embodiments may provide such recommendations by analyzing various factors relating to the geographic location, weather, economic considerations and crop-specific requirements. Such analysis may be made in consideration of a target or chosen planting date, and so recommendations may be time dependent.

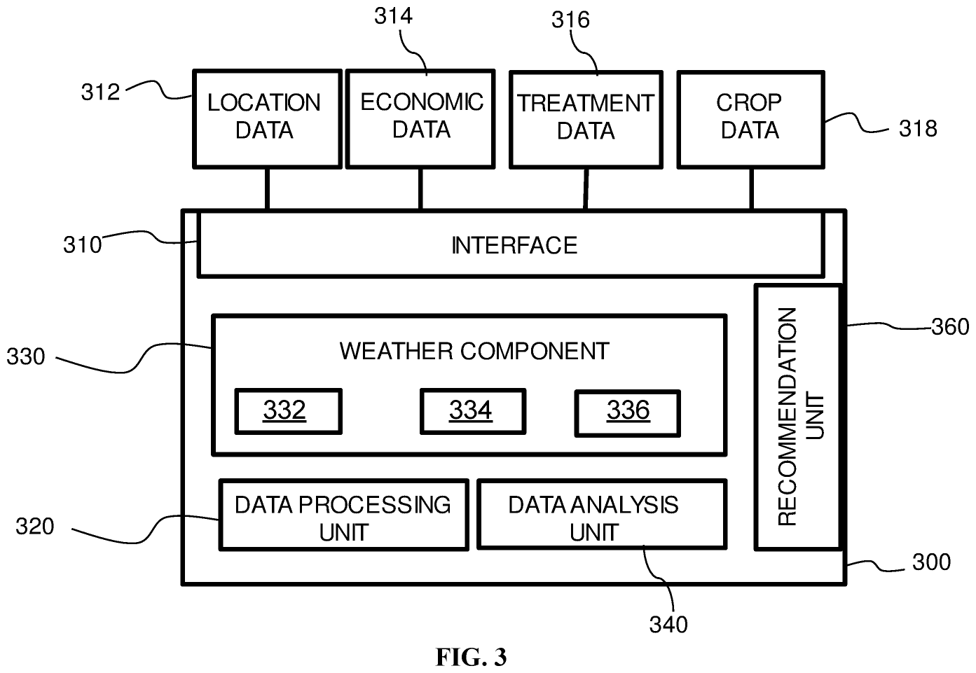

FIG. 3 is a simplified block diagram of an example embodiment of a system 300 for crop management for a geographical space. Here, the geographical space is a subspace/sub-area of a geographic area. For instance, the geographical space comprises a field for a crop, and the geographic area comprises a town or county including the field.

The system 300 comprises an interface 310 configured to obtain various data. In particular, the interface 310 is configured to obtain: location data 312 relating to the geographical space; economic data 314 relating to one or more crop types; treatment data 316 relating to the one or more crop types; and crop data 318 relating to the one or more crop types. Such data may, for example, be retrieved from (local or remotely located) data storage units (e.g., databases) that are provisioned with information from various sensors, knowledge bases and experts.

A data processing unit 320 of the system 300 is configured to determine a seed treatment recommendation as function of the obtained data. Further, based on the crop determined treatment recommendation, the data processing unit 320 is configured to determine a recommended crop type. In other words, the data processing unit 320 is configured to process the various forms of data obtained by via interface 310 so as to identify a preferred or optimal crop type for the geographical space.

A weather component 330 of the system 300 is configured to obtain weather information for the geographical space for a predetermined time frame prior to a planned planting date. In this example, the weather component 330 is configured to generate a model based on the obtained rainfall information and temperature information. The model is configured to represent a relationship between rainfall and ambient temperature for geographic area including the geographical space.

More specifically, in this example embodiment, the modeling component 330 comprises a data analysis unit 332 that is configured to analyze the obtained rainfall information and temperature information to determine a correlation between rainfall for the geographic area and ambient temperature for the geographic area. In particular, the data analysis unit 332 is configured to process the obtained rainfall information and temperature information with one or more machine learning algorithms to determine a correlation between rainfall for the geographic area and ambient temperature for the geographic area.

In particular, this example embodiment takes the obtained readings for temperature and rainfall and plots them against each other. A linear regression technique is then used to determine a statistical relationship between the two and then that function is used to fill in rainfall readings for sections of time when those readings were absent but temperature readings were present. In areas where rainfall readings were entirely absent or insufficient, an approach based on the similarity (where similarity could cover terrain type, location, elevation etc.) of an area to an area of known temp-rainfall function could be used to determine—this is where machine learning algorithms may be employed for example.

The modeling component 330 also comprises a function generator 334 that is configured to determine one or more functions for describing the determined correlation between rainfall for the geographic area and ambient temperature for the geographic area. A model generator 336 of the modeling component is then configured to generate a model representing a relationship between rainfall and ambient temperature for the geographic area based on the one or more functions determined by the function generator 334. Here, conventional regression techniques are employed, although it will be understood the various known function identification techniques may be employed by other embodiments.

The model generator 336 is also configured to determine a temperature threshold for the geographical space based on the generated model. Here, the temperature threshold is determined so that it identifies a crop planting or production condition. More specifically, the model generator 336 is configured to determine an ambient temperature value that the model indicates has a related value of rainfall which meets a predetermined requirement for the crop (such as minimum required rainfall or optimal rainfall, for example). Such requirements may be crop-specific. By way of example, it may be known for a particular crop type that optimal crop production is achieved when the rainfall exceeds a certain daily average over the course of a month. Using this information, the model can be used to identify the temperature which is related to that daily average rainfall amount. The identified temperature can then be used as the temperature threshold. This temperature threshold may be useful for indicating when the crop should be planted in the geographical space (e.g., by identifying a temperature at which the geographical space should be for a specified time period prior to crop planting).

A data analysis unit 340 of the system 300 is configured determine a seed planting amount based on the recommended crop type (determined by the data processing unit 320) and the weather information (obtained by the weather component 330).

A crop recommendation unit 360 of the system 300 is configured to generate a crop purchase recommendation based on the seed planting amount and crop type recommendation. For instance, the crop recommendation unit 360 is configured to communicate instructions to the user advising him/her of the recommended planting amount and crop type. In this way, a user is advised as to what crop type should be planted in the geographical space and how much of the crop type should be purchased.

Thus, considering an example use-case of planning the planting of a crop in a specific field, it will be appreciated that the system 300 of FIG. 3 may provide for the identification of an optimized crop type and planting amount to ensure maximal crop profit and/or yield.

Proposed embodiments may be summarized as determining two recommendations for a geographical space, namely a crop type and a seed planting amount.

Determining Crop Type

Determining the recommended crop type (e.g., wheat, barley, maize, etc.) employs various data inputs such as:
location information l—e.g., location data regarding factors such as: soil data relating to the soil of the geographic space; irrigation status data relating to irrigation properties of the geographic space; and/or geographic data relating to geographic properties of the geographic space;
economic information e—e.g., economic data regarding factors such as: crop pricing data relating to a current price of the one or more crop types; crop future data relating to future pricing of the one or more crop types; and/o refund data relating to refund/returns availability for the one or more crop types;
historical data h—e.g., historical data relating to previous values or observations for one or more crop types;
treatment data t—comprising information such as: treatment substance data relating to pesticide, herbicide, fungicide or fertilizer requirements of the one or more crop types; treatment pricing data relating to a current price of treatment substances for the one or more crop types; and/or treatment future data relating to future pricing of treatment substances for the one or more crop type;
crop data c—including information such as yield data relating to expected yields of the one or more crop types; crop requirement data relating to planting or growth requirements of the one or more crop types; and/or irrigation data relating to irrigation requirements of the one or more crop types

Accordingly, embodiment propose that recommended crop type may be a function of these various data types:

Crop Type=f(l, e, h, t, c) (i)

Determining Seed Planting Amount

Determining a seed planting amount (e.g., amount of seed to purchase) is proposed to combine crop-type attributes and requirements with the weather information for the geographical space to determine what quantity of the crop to buy (e.g., to maximize profit, yield, or quality).

Here, the proposed approach is to obtain weather information for the geographical space for a predetermined timeframe prior to a planned planting date. This may, for example, provide an understanding of moisture levels in the soil by taking an aggregate of timeframe prior to the intended planting date d. Such understanding can leverage forecast information and/or measured conditions, for example.

Combining the weather information with crop-type attributes, a preferred or optimal quantity to purchase may then be determined. By way of example, a stochastic optimization algorithm configured to maximize yield may be employed with the weather information and crop-type attributes as input. For instance, the Stochastic Gradient Descent method for optimizing a differentiable objective function (a stochastic approximation of gradient descent optimization) may be employed.

It is to be understood that the example implementations detailed above are just examples of many possible implementations that may be employed to determine crop recommendations for a geographical space. Accordingly, there are many other potential implementations that could also be used.

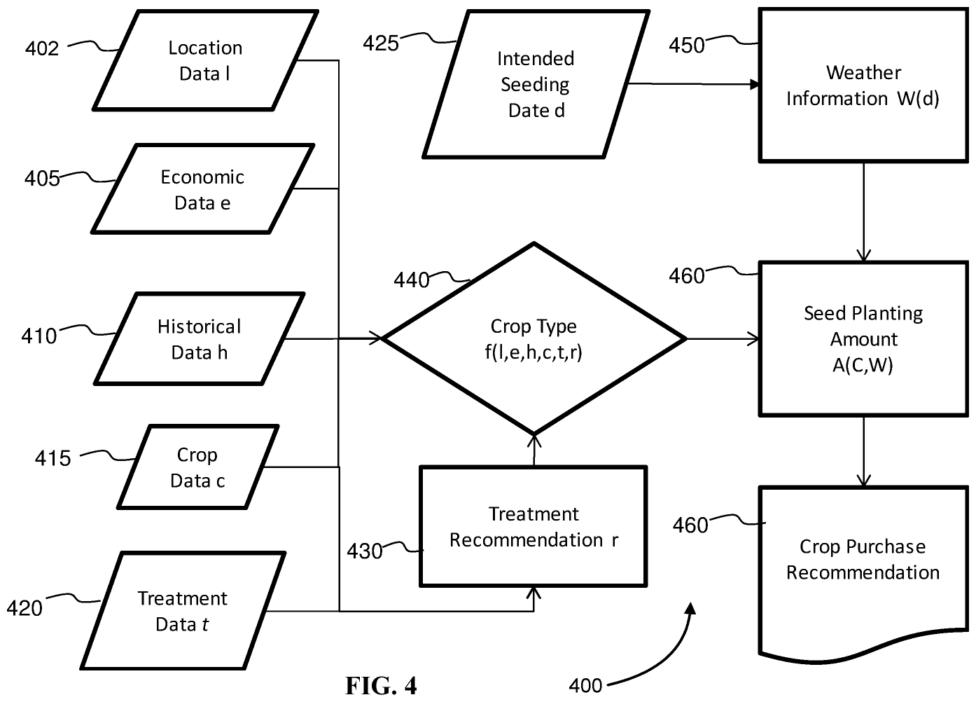

Referring now to FIG. 4, there is depicted a flow diagram of a computer-implemented method 400 for a crop recommendation for a geographical space, according to an embodiment. In this example, the geographical space is defined by the boundary of a crop to be planted and substantially matches that of a field or plot of agricultural land.

The method 400 is provided with first to sixth input data types.

More specifically, the first input data type comprises location data 402(l) relating to the geographical space. Here, the location data 402 comprises at least one of soil data relating to the soil of the geographic space, irrigation status data relating to irrigation properties of the geographic space, and geographic data relating to geographic properties of the geographic space.

The second input data type comprises economic data 405(e) relating to one or more crop types. Here, the economic data 405 comprises at least one of crop pricing data relating to a current price of the one or more crop types, crop future data relating to future pricing of the one or more crop types, and refund data relating to refund availability for the one or more crop types.

The third input data type comprises historical data 410(h) relating to one or more crop types. Here, the historical data 410 comprises at least one of production history data relating to previously obtained crop production values for the one or more crop types and observation data relating previously-obtained observations for the one or more crop types.

The fourth input data type comprises crop data 415(c) relating to the one or more crop types. Here, the crop data 415 comprises at least one of yield data relating to expected yields of the one or more crop types, crop requirement data relating to planting or growth requirements of the one or more crop types, and irrigation data relating to irrigation requirements of the one or more crop types.

The fifth input data type comprises treatment data 420(t) relating to the one or more crop types. Here, the treatment data 420 comprises at least one of treatment substance data relating to pesticide, herbicide, fungicide or fertilizer requirements of the one or more crop types; treatment pricing data relating to a current price of treatment substances for the one or more crop types; and treatment future data relating to future pricing of treatment substances for the one or more crop type.

The sixth input data type comprises date data 425(d) relating to an intended seeding date.

Step 430 comprises determining a seed treatment recommendation based on at least one of the first to fifth input data types. For instance, information about pesticide, herbicide, fungicide or fertilizer requirements of the one or more crop types can be combined with information about planting and irrigation requirements of the crop types to determine recommended pesticide, herbicide, fungicide or fertilizer treatments (e.g., a seed treatment recommendation (r)).

Following step 430, a recommended crop type is determined in step 440 as a function of the seed treatment recommendation. In this example, step 440 is further based on the first to fifth input data types. Put another way step 440 determines a recommended crop type as a function of l, e, h, c, t, and r, i.e. crop type=f(l,e,h,c,t,r).

Step 450 comprises determining weather information for the geographical space based on the date data 425(d). More specifically, step 450 comprises determining weather information for a predetermined timeframe prior to the intended (e.g., planned) planting date. The weather data may for example leverage forecast information and/or measured conditions for a geographical area encompassing the geographical space, for example. Such information may therefore provide an understanding of current and/or potential soil conditions (e.g., moisture levels).

In step 460, a seed planting amount (e.g., seed purchasing amount) is determined based on the recommended crop type (determined in step 440) and the weather information (determined in step 450). Here, the step 460 of determining the seed planting amount combines attributes of the recommended crop type with the weather information to determine the what quantities to buy in order to maximize profit. This may, for example, employ a stochastic optimisation algorithm with the above inputs to maximise yield based on the available field zones (e.g., a Stochastic Gradient Decent algorithm).

Finally, in step 460, a crop purchase recommendation is generated and provided as an output. The crop purchase recommendation is based on the seed planting amount (determined in step 460) and the crop type recommendation (generated in step 440). The crop purchase recommendation therefore comprises information for advising a user which crop type is recommended for the geographical space and how much seed of that crop type to purchase.

From the above description, it will be appreciated that proposed embodiments may utilize input such as: crop futures; seed prices; historical crop data; returns availability; field information; and weather information to generate a recommendation as to what crop is most likely to be profitable for a specific geographical space and planned planting date. Using historical weather and long term forecasts, embodiment may also inform this process and the likelihood of what treatment regimens will be necessary. Further, seed treatment recommendation(s) may factor into cost/profit considerations.

Accounting for the consideration that the weather (and associated soil conditions) may impact germination, embodiments may employ further concepts regarding determination of weather information.

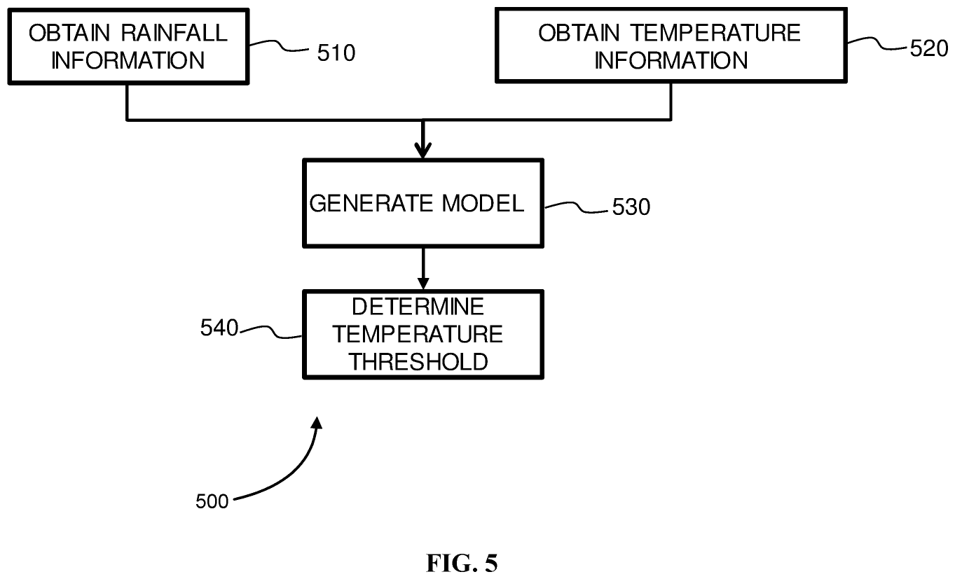

By way of example, FIG. 5 depicts a computer-implemented method for determining weather information according to an embodiment. For instance, the method of FIG. 5 may be employed in step 450 of FIG. 4.

Step 510 comprises obtaining rainfall information relating to sensed rainfall for a geographic area within a time period. Here, the geographic area is a town within which the geographical space of the field/plot is situated. In this way, the geographic area may be larger than, and includes, the geographical space. Example rainfall information obtained may include measured values of daily rainfall for the town (e.g., inches or millimeters of rain per day) for a time period of months or years.

Step 520 comprises obtaining temperature information relating to sensed ambient temperature for the geographic area within the time period. Example temperature information obtained may thus include measured average and/or peak temperature per day for the town (e.g., degrees Celsius/Fahrenheit/Kelvin) for a time period of months or years.

In step 530 a model is generated based on the obtained rainfall information and temperature information. The model is configured to represent relationship between rainfall and ambient temperature for the geographic area.

By way of example, in this embodiment, step 530 comprises analyzing the obtained rainfall information and temperature information to determine a correlation between rainfall for the geographic area and ambient temperature for the geographic area. More specifically, analyzing the obtained rainfall information and temperature information comprises processing the obtained rainfall information and temperature information with one or more machine learning algorithms to determine a correlation between rainfall and ambient temperature for the geographic area. Step 530 may further comprise determining one or more functions for describing the determined correlation between rainfall and ambient temperature for the geographic area and generating a model representing a relationship between rainfall and ambient temperature for the geographic area, based on the one or more functions.

Based on the generated model (from step 530), a temperature threshold for the geographical space is generated. The temperature threshold is for identifying a crop planting or production condition. More specifically, in this example, the temperature threshold is determined by identifying an ambient temperature value that the model indicates has a related value of rainfall which meets a predetermined planting/growth requirement for the crop (e.g., minimum or maximum rainfall). In this way, it may be identified when a detected ambient temperature is such that its related rainfall meets the predetermined planting/growth requirement for the crop.

In a restricted space/area, this may enable temperature measurements to be used as a proxy for rainfall where rainfall data may be absent for the restricted space/area. For instance, while temperature measurements may be easily obtainable for a limited geographical space, rainfall information for the same limited geographical space may be much harder to gather (and is therefore more likely to be partially absent). Using a relationship determined for rainfall and temperature information data that is available for a larger geographic area can be leveraged to generate a model, which can then in turn be used for a more limited geographical space within the larger geographic area.

For large datasets covering large geographic areas, machine learning techniques and processes may be used be used to determine the relationship(s) between temperature and rainfall across the geographic area. Embodiments may therefore generate a single model without having to compute multiple relationships in order to apply a model across an extended area or to apply a model throughout a whole year rather than determining the relationship in each season.

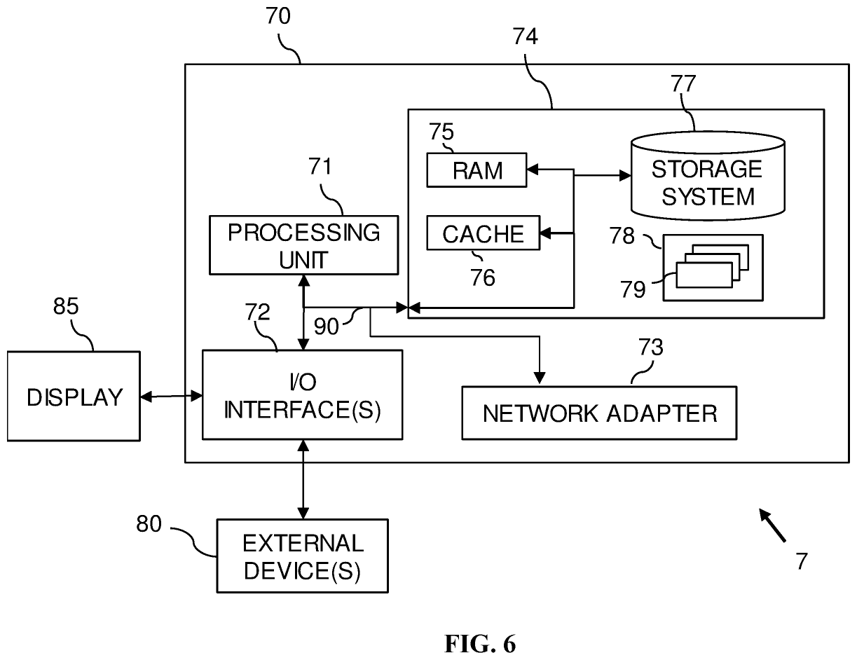

By way of further example, as illustrated in FIG. 6, embodiments may comprise a computer system 70, which may form part of a networked system 7. The components of computer system/server 70 may include, but are not limited to, one or more processing arrangements, for example comprising processors or processing units 71, a system memory 74, and a bus 90 that couples various system components including system memory 74 to processing unit 71.

Bus 90 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 70 typically includes a variety of computer system readable media. Such media may be any available media that is accessible by computer system/server 70, and it includes both volatile and non-volatile media, removable and non-removable media.

System memory 74 can include computer system readable media in the form of volatile memory, such as random access memory (RAM) 75 and/or cache memory 76. Computer system/server 70 may further include other removable/non-removable, volatile/non-volatile computer system storage media. By way of example only, system memory 74 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 90 by one or more data media interfaces. As will be further depicted and described below, system memory 74 may include at least one program product having a set (e.g., at least one) of program modules that are configured to carry out the functions of embodiments of the disclosure.

Program/utility 78, having a set (at least one) of program modules 79, may be stored in memory 74 by way of example, and not limitation, as well as an operating system, one or more application programs, other program modules, and program data. Each of the operating system, one or more application programs, other program modules, and program data or some combination thereof, may include an implementation of a networking environment. Program modules 79 generally carry out the functions and/or methodologies of embodiments of the disclosure as described herein.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73. As depicted, network adapter 73 communicates with the other components of computer system/server 70 via bus 90. It should be understood that although not shown, other hardware and/or software components could be used in conjunction with computer system/server 70. Examples, include, but are not limited to: microcode, device drivers, redundant processing units, external disk drive arrays, RAID systems, tape drives, and data archival storage systems, etc.

In the context of the present application, where embodiments of the present disclosure constitute a method, it should be understood that such a method is a process for execution by a computer (e.g., a computer-implementable method). The various steps of the method therefore reflect various parts of a computer program (e.g., various parts of one or more algorithms).

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for crop recommendation for a geographical space, the method comprising:
determining a seed treatment recommendation based on location data relating to the geographical space, economic data relating to one or more crop types, treatment data relating to the one or more crop types, and crop data relating to the one or more crop types;
determining a recommended crop type based on the seed treatment recommendation;
determining weather information for the geographical space for a predetermined timeframe prior to a planned planting date; and
determining a seed planting amount based on the recommended crop type and the weather information.

2. The method of claim 1, wherein determining the seed treatment recommendation is further based on historical data relating to the one or more crop types.

3. The method of claim 1, wherein determining the seed planting amount employs a stochastic optimization algorithm for identifying a crop amount for maximizing crop yield.

4. The method of claim 1, wherein the location data comprises soil data relating to the soil of the geographic space, irrigation status data relating to irrigation properties of the geographic space, and geographic data relating to geographic properties of the geographic space.

5. The method of claim 1, wherein the economic data comprises crop pricing data relating to a current price of the one or more crop types, crop future data relating to future pricing of the one or more crop types, and refund data relating to refund availability for the one or more crop types.

6. The method of claim 1, wherein the treatment data comprises treatment substance data relating to pesticide, herbicide, fungicide or fertilizer requirements of the one or more crop types; treatment pricing data relating to a current price of treatment substances for the one or more crop types; and treatment future data relating to future pricing of treatment substances for the one or more crop type.

7. The method of claim 1, wherein the crop data comprises yield data relating to a set of expected yields of the one or more crop types, crop requirement data relating to planting and growth requirements of the one or more crop types, and irrigation data relating to irrigation requirements of the one or more crop types.

8. The method of claim 2, wherein the historical data comprises production history data relating to previously obtained crop production values for the one or more crop types and observation data relating previously-obtained observations for the one or more crop types.

9. The method of claim 1, further comprising generating a crop purchase recommendation based on the seed planting amount and crop type recommendation.

10. The method of claim 1, wherein determining weather information comprises:
obtaining rainfall information relating to sensed rainfall for a geographic area within a time period, wherein the geographic area includes the geographical space;
obtaining temperature information relating to sensed ambient temperature for the geographic area within the time period;
generating a model based on the obtained rainfall information and temperature information, the model representing a relationship between rainfall and ambient temperature for the geographic area; and
determining a temperature threshold for the geographical space based on the generated model, wherein the temperature threshold is for identifying a crop planting or production condition.

11. The method of claim 10, wherein determining the temperature threshold for the geographic space comprises determining an ambient temperature value that the model indicates has a related value of rainfall which meets a predetermined requirement.

12. The method of claim 10, wherein generating the model comprises:
analyzing the obtained rainfall information and temperature information to determine a correlation between rainfall for the geographic area and ambient temperature for the geographic area;
determining one or more functions for describing the determined correlation between rainfall and ambient temperature for the geographic area; and
generating the model representing a relationship between rainfall and ambient temperature for the geographic area, based on the one or more functions.

13. The method of claim 12, wherein analyzing the obtained rainfall information and temperature information comprises processing the obtained rainfall information and temperature information with one or more machine learning algorithms to determine a correlation between rainfall and ambient temperature for the geographic area.

14. The method of claim 10, further comprising:
obtaining information indicative of a detected ambient temperature for the geographic space; and
detecting a crop planting or production condition for the geographical space, based on the detected ambient temperature for the geographic space and the temperature threshold.

15. The method of claim 1, wherein the geographical space is defined by a boundary of one or more fields.

16. A computer program product for crop recommendation for a geographical space, the computer program product comprising a computer readable storage medium having program instructions embodied therewith, the program instructions executable by a processing unit to cause the processing unit to perform a method comprising:
determining a seed treatment recommendation based on location data relating to the geographical space, economic data relating to one or more crop types, treatment data relating to the one or more crop types, and crop data relating to the one or more crop types;
determining a recommended crop type based on the seed treatment recommendation;
determining weather information for the geographical space for a predetermined timeframe prior to a planned planting date; and
determining a seed planting amount based on the recommended crop type and the weather information.

17. The computer program product of claim 16, wherein determining the seed treatment recommendation is further based on historical data relating to the one or more crop types.

18. The computer program product of claim 16, wherein determining the seed planting amount employs a stochastic optimization algorithm for identifying a crop amount for maximizing crop yield.

19. A system for crop recommendation for a geographical space, the system comprising:
a data processing unit configured to determine a seed treatment recommendation based on location data relating to the geographical space, economic data relating to one or more crop types, treatment data relating to the one or more crop types, and crop data relating to the one or more crop types, the data processing unit further configured to determine a recommended crop type based on the seed treatment recommendation;
a weather component configured to determine weather information for the geographical space for a predetermined timeframe prior to a planned planting date; and
a data analysis unit configured to determine a seed planting amount based on the recommended crop type and the weather information.

20. The system of claim 19 further comprising:
a crop recommendation unit configured to generate a crop purchase recommendation based on the seed planting amount and crop type recommendation.
